(19) United States
(12) Patent Application Publication
(10) Pub. No.: US 2020/0266726 A1
(43) Pub. Date: Aug. 20, 2020

(54) RECTIFIER CIRCUIT AND POWER SUPPLY UNIT

(71) Applicant: Sharp Kabushiki Kaisha, Sakai City (JP)

(72) Inventor: Takeshi SHIOMI, Sakai City (JP)

(21) Appl. No.: 16/787,271

(22) Filed: Feb. 11, 2020

(30) Foreign Application Priority Data
Feb. 19, 2019 (JP) 2019-027561

(51) Int. Cl. H02M 7/217; H02M 1/00

(52) U.S. Cl. CPC H02M 7/217; H02M 2001/0051; H02M 1/00

(57) ABSTRACT

The present disclosure, in an aspect thereof, has an object to effectively reduce transient current in a rectifier circuit. In a rectifier circuit, a current flows from a power supply to a coil when a transistor is turned on. Then, when the transistor is turned off, a second rectifier current flows from the coil to a second rectifier, and a first reverse voltage is applied across the rectifier circuit.

### TECHNICAL FIELD

The following disclosure relates to rectifier circuits.

### BACKGROUND ART

It is known that a transient current can occur in a rectifier used in power supply circuits. Transient current is generated when a reverse voltage is applied to inhibit a current in the rectifier. Various solutions have been studied because the transient current causes loss in the power supply circuit.

Patent Literature 1 (Japanese Unexamined Patent Application Publication, Tokukai, No. 2011-36075) and Patent Literature 2 (Japanese Unexamined Patent Application Publication, Tokukai, No. 2013-198298) disclose a circuit one of the purposes of which is to reduce transient current. The circuit disclosed in Patent Literature 1, as an example, includes a diode and a transformer that are connected in parallel with a rectifier to reduce transient current.

Patent Literature 2 discloses a similar circuit.

### SUMMARY OF INVENTION

### Technical Problem

There is still room for improvement in the technique of reducing transient current in a rectifier circuit as will be described later in detail. The present disclosure, in an aspect thereof, has an object to effectively reduce transient current in a rectifier circuit.

### Solution to Problem

To achieve the object, the present disclosure, in an aspect thereof, is directed to a rectifier circuit causing a rectification current to flow from a second terminal to a first terminal, the rectifier circuit including: a third terminal between the first terminal and the second terminal; a first rectifier connected to the first terminal and the second terminal; a second rectifier connected to the first terminal and the third terminal; a coil connected to the third terminal and the second terminal; a transistor having a drain or collector connected to the third terminal; and a power supply having a positive terminal connected to the second terminal and a negative terminal connected to a source or emitter of the transistor, wherein the coil applies a first reverse voltage across the rectifier circuit.

### Advantageous Effects of Invention

The present disclosure, in an aspect thereof, provides a rectifier circuit that can effectively reduce transient current.

### BRIEF DESCRIPTION OF DRAWINGS

FIG. 1 is a circuit diagram of a power supply circuit in accordance with Embodiment 1.

FIG. 2 is a set of diagrams of voltage and current waveforms.

FIG. 3 is a diagram collectively showing the graphs in FIG. 2 on an enlarged scale.

Portions (a) to (d) of FIG. 4 are diagrams showing current paths in first to fourth steps respectively.

FIG. 5 is a diagram of voltage and current waveforms in a power supply circuit in accordance with a comparative example.

FIG. 6 is a diagram representing the voltage dependency of Coss in a device.

FIG. 7 is a diagram representing the voltage dependency of Coss in some devices.

FIG. 8 is a diagram of a power supply unit in accordance with Embodiment 2.

### DESCRIPTION OF EMBODIMENTS

### Embodiment 1

The following will describe a rectifier circuit 1 and a power supply circuit 10 in accordance with Embodiment 1. For convenience of description, members of Embodiment 2 and any subsequent embodiments that have the same function as members described in Embodiment 1 will be indicated by the same reference numerals, and description thereof is omitted.

### Purpose of Rectifier Circuit 1

Transient current occurs in a rectifier as described earlier. It is known that a transient current can primarily occur in a rectifier having a PN junction.

SiC-SBD's (Schottky barrier diodes) and GaN HEMT's (high electron mobility transistors) are examples of semiconductor devices with no PN junctions. In these semiconductor devices, no transient current occurs that is attributable to a PN junction. However, charge current for parasitic capacitance under a reverse voltage flows as a transient current. The rectifier circuit 1 has been created for the purpose of reducing these transient currents.

### Definition of Terms

Various terms used in the present specification are defined in the following prior to a description of the rectifier circuit 1.

A forward voltage is a voltage generating a forward current in a rectifier.

Consider, as a first example, a situation where the rectifier is a diode. A forward voltage in such a situation is a voltage applied to generate a forward current in the diode.

Consider, as a second example, a situation where the rectifier is a transistor. A forward voltage in such a situation is a voltage at which a rectification current flows with the gate being turned off and the source being placed under a positive voltage with reference to the drain.

These two examples are equivalent to applying, to a second terminal ST1 (detailed later) of the rectifier circuit 1, a positive voltage with reference to a first terminal FT1 (detailed later) of the rectifier circuit 1.

The magnitude of the forward voltage varies depending on the device type and is, for example, from 0.1 V to 5 V. The magnitude of the forward current generated under a forward voltage varies depending on the current in a coil and other like inductive device and is, for example, from 0.1 A to 100 A.

A rectification current is a forward current in a rectifier or a rectifier circuit.

A reverse voltage is a voltage applied to a rectifier or a rectifier circuit so that the rectifier or the rectifier circuit does not conduct in the forward direction.

Consider, as a first example, a situation where the rectifier is a diode. A reverse voltage in such a situation is a voltage applied so that no forward current can flow in the diode.

Consider, as a second example, a situation where the rectifier is a transistor. A reverse voltage in such a situation is a positive voltage, with reference to the source, applied to the drain with the gate being turned off.

These two examples are equivalent to applying, to FT1 of the rectifier circuit 1, a positive voltage with reference to ST1 of the rectifier circuit 1. The magnitude of the reverse voltage varies depending on circuit specifications and is, for example, from 1 V to 1,200 V.

A first reverse voltage is an instantaneous reverse voltage applied to a rectifier circuit by a coil's energy. A reverse voltage, if lasting for 10% or less of a switching cycle, may be regarded instantaneous because such a short-time reverse voltage does not affect much of the circuit operation. In Embodiment 1, a switching cycle is 10 μsec, and any period lasting for 1 μsec or less may be regarded instantaneous.

A second reverse voltage is a reverse voltage that is, unlike the first reverse voltage, applied continuously. A simple form, “reverse voltage,” refers to this second reverse voltage. The second reverse voltage is, for example, a reverse voltage in a duty period.

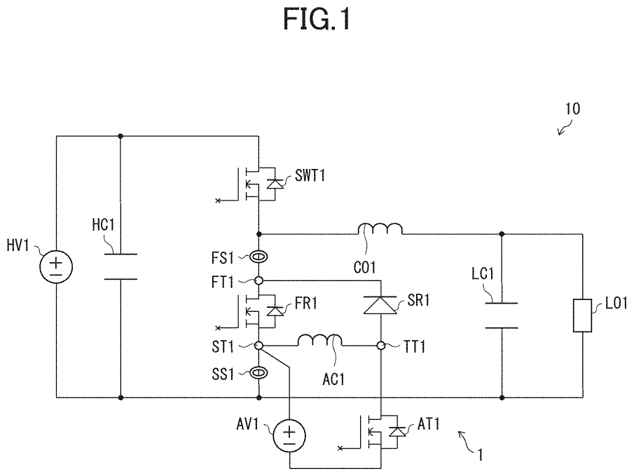

A transient current is a collective term for reverse recovery current and charge current for parasitic capacitance of a rectifier. In other words, a transient current is an instantaneous current generated when a reverse voltage is applied to the rectifier. Transient current can be measured at FS1 and SS1 in the example shown in FIG. 1.

A rectification function is a function to cause a mono-directional current flow, but no bidirectional current flow.

Consider, as a first example, a situation where the rectifier is a diode. A rectification function in such a situation is a function of the diode allowing a forward current and blocking a reverse current.

Consider, as a second example, a situation where the rectifier is a transistor. A rectification function in such a situation is a function to allow a current from the source to the drain and block a current from the drain to the source, with the gate being turned off.

A rectifier is a collective term for devices capable of the rectification function.

A transistor function is a function of a transistor switching on/off a current flow from the drain to the source by turning on/off the gate. Needless to say, the drain needs to be biased positively relative to the source to allow a current flow.

When the device is a bipolar transistor or an IGBT (insulated gate bipolar transistor), the same definitions apply by (i) reading the drain as the collector and (ii) the source as the emitter.

A transistor device is a collective term for devices with the transistor function.

### Brief Description of Structure of Power Supply Circuit 10

FIG. 1 is a circuit diagram of the power supply circuit 10 in accordance with Embodiment 1. The power supply circuit 10 is a step-down DC/DC converter that steps down high voltage to low voltage. The power supply circuit 10 includes the rectifier circuit 1 in place of a rectifier in a publicly known step-down DC/DC converter. The following description includes numerical values for illustrative purposes only.

### Structure of High-Voltage Section of Power Supply Circuit 10

The high-voltage section includes a power supply HV1 and a capacitor HC1. The following description may include abbreviated notation, for example, “HV1” for “power supply HV1” for convenience of description. HV1 supplies a voltage of 400 V. HC1 has a capacitance of 3.3 mF. The side of a power supply symbol marked with “+” indicates a positive terminal of the power supply, whereas the side marked with “−” indicates a negative terminal of the power supply. HV1 has a negative terminal voltage of 0 V.

### Structure of Low-Voltage Section of Power Supply Circuit 10

The low-voltage section includes a coil CO1, a capacitor LC1, and a load LO1. CO1 has an inductance of 500 pH and an average current of 14 A. There is a voltage of 200 V across LC1. The power supply circuit 10 is designed so that the voltage across LC1 is half that across HC1.

### Structure of Rectifier Circuit 1 of Power Supply Circuit 10

A typical rectifier circuit includes a first rectifier FR1. In contrast, apart from a first rectifier FR1, the rectifier circuit 1 additionally includes a second rectifier SR1, a coil AC1, a transistor AT1, and a power supply AV1.

The first rectifier FR1 is a cascode GaN HEMT. FR1 has a drain breakdown voltage of 650 V and an ON resistance of 50 mΩ. The example shown in FIG. 1 uses the same schematic symbol as a MOSFET (metal-oxide semiconductor field-effect transistor) to represent a cascode GaN HEMT.

The second rectifier SR1 is a SiC-SBD with a breakdown voltage of 650 V. SR1 allows a forward voltage of 0.9 V upon starting to conduct and a resistance of 50 mΩ while conducting in the forward direction.

The coil AC1 is a coil with an inductance of 1 μH and a DC resistance of 50 mΩ.

The transistor AT1 is a MOSFET with an ON resistance of 40 mΩ.

The power supply AV1 is a 15-V power supply. AV1 has a positive terminal connected to ST1. In Embodiment 1, AV1 has a negative terminal voltage of −15 V because ST1 is at 0 V. AV1 has a negative terminal connected to the source of AT1.

The first terminal FT1 provides an electrical connection between FR1 and SR1.

The second terminal ST1 provides an electrical connection between FR1, AC1, and AV1.

A third terminal TT1 provides an electrical connection between SR1, AC1, and AT1.

“FS1” and “SS1” denote points where current can be measured in the rectifier circuit 1. FS1 and SS1 will give equal current measurements. Any current sensor may be used including a hole-element type current sensor, a CT (current transformer) sensor, a Rogowski coil, and a shunt resistance system.

### Structure of Transistor Function Section of Power Supply Circuit 10

The transistor function section includes a transistor SWT1.

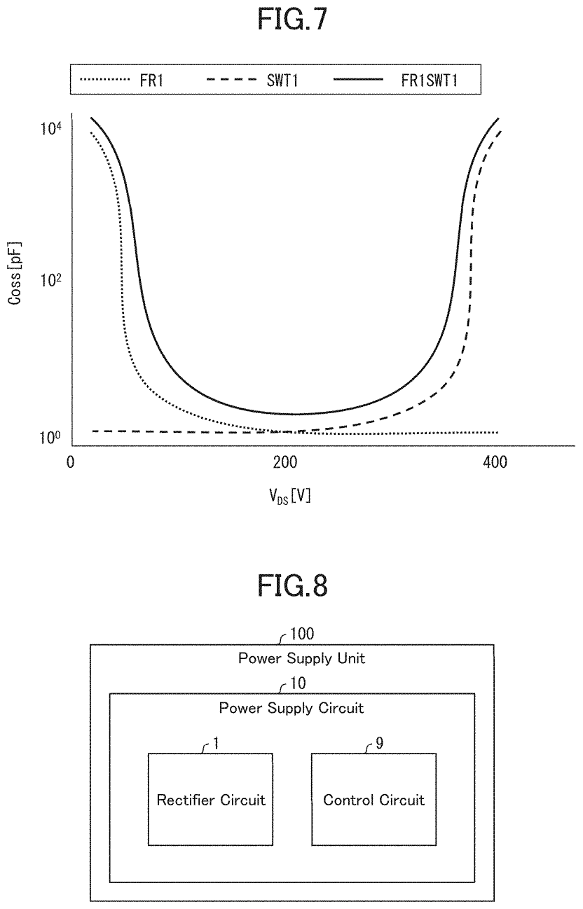

Each device in the power supply circuit 10 has a gate terminal connected to a control circuit 9 shown in FIG. 8 (detailed later), so that the gates can be turned on and off by the control circuit 9.

### Structure of Power Supply Circuit as Comparative Example

A step-down DC/DC converter as a comparative example (hereinafter, a “power supply circuit”) will be described first in detail in terms of a relationship between its operation and transient current. The power supply circuit is built around a common rectifier described above.

### Operation 1 of Comparative Example

First, the switch node is at a voltage of approximately 400 V while SWT1 is ON. CO1 is therefore placed under a voltage of approximately 200 V, thereby increasing the coil current. The coil current flows following a path, HV1 (positive terminal)→SWT1→CO1→LO1→HV1 (negative terminal).

### Operation 2 of Comparative Example

Next, SWT1 is turned off. The electromotive force of CO1 consequently places ST1 at a higher voltage than FT1 by approximately 1 V. This voltage of approximately 1 V is applied to FR1 as a forward voltage, generating a rectification current flowing from FR1 to CO1. The rectification current flow following a path, LO1→FR1→CO1→LO1.

### Operation 3 of Comparative Example

Subsequently, SWT1 is turned on, which changes the voltage at the switch node to approximately 400 V. A reverse voltage of approximately 400 V is therefore applied to FR1, thereby generating a transient current.

This set of operations 1 to 3 is repeatedly performed at a frequency of 100 kHz. SWT1 has a duty ratio of 50%. FR1 is therefore placed alternately under a forward voltage and a reverse voltage every 5 μsec.

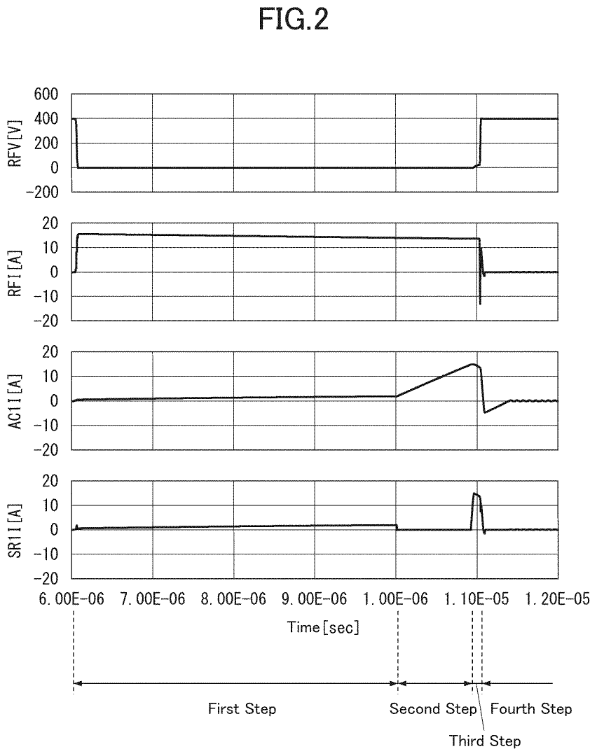

### Description of FIGS. 2 to 4 Illustrating Operations of Rectifier Circuit 1

FIG. 2 is a set of graphs representing four voltage and current waveforms in the rectifier circuit 1. All the waveforms are drawn on a common time axis (horizontal axis). The four waveforms represent:

RFV (voltage across the rectifier circuit 1), which is a voltage applied to FT1 relative to ST1;

RFI (current through the rectifier circuit 1), which is a current flowing from ST1 to FT1;

AC1I (current through AC1), which is a current flowing from ST1 to TT1; and

SR1I (current through SR1), which is a current flowing from TT1 to FT1.

FIG. 2 shows, on its horizontal axis, timings for first to fourth steps (detailed later). SR1I may alternatively be referred to as the second rectifier current.

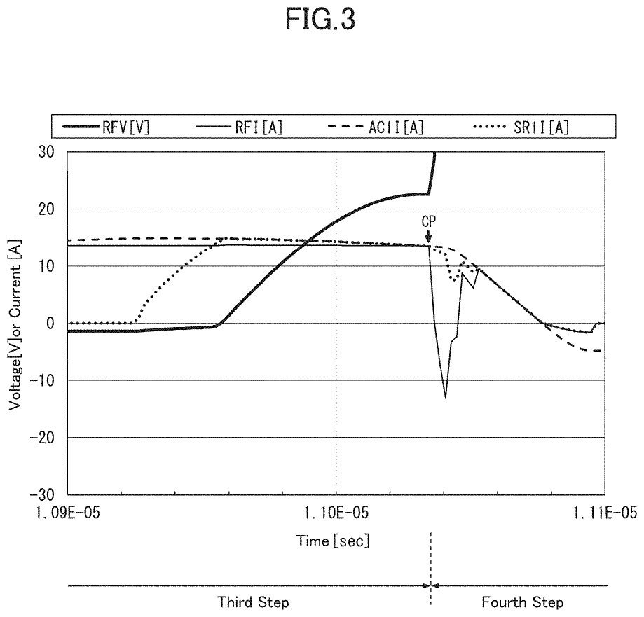

FIG. 3 is a diagram collectively showing the graphs of the four waveforms in FIG. 2 in a single graph on an enlarged scale. FIG. 3 shows RFV rising beyond the top of the graph for convenience in drawing the waveforms on an enlarged scale.

FIG. 4 is a set of diagrams showing current paths in the first to fourth steps. Specifically, portions (a) to (d) of FIG. 4 represent current paths in the first to fourth steps respectively. FIG. 4 omits some of the reference numerals and symbols shown in FIG. 1 for convenience.

### How Rectifier Circuit 1 is Driven: First to Fourth Steps

According to a method of driving the rectifier circuit 1, the following four steps are performed in this sequence:

A first step of applying a forward voltage across the rectifier circuit 1 to generate a rectification current;

A second step of turning on AT1 to generate a current flowing through AC1;

A third step of turning off AT1 to generate a current flowing through SR1 and applying a first reverse voltage across the rectifier circuit 1; and

A fourth step of applying a second reverse voltage across the rectifier circuit 1 to stop the rectification current

### First Step: Generating Rectification Current Flowing Through Rectifier Circuit

Prior to the first step, current is flowing from SWT1 to CO1. SWT1 is accordingly turned off in the first step, thereby generating in CO1 an electromotive force that in turn leads to the application of a forward voltage of approximately 1 V across the rectifier circuit 1 and the generation of a rectification current flowing through FR1. The rectification current flows following the path shown in (a) of FIG. 4.

The current through SR1 is smaller than the current through FR1 in the first step. SR1I, which is shown in (c) to (d) of FIG. 4, is omitted in (a) of FIG. 4 for this reason.

### Second Step: Generating Current Flowing Through AC1

Subsequent to the first step, AT1 is turned on, thereby generating AC1I to flow. The coil hence accumulates energy. AC1I flows following the path shown in (b) of FIG. 4. AC1I increases more or less linearly with time.

### Third Step, First Substep: Generating Current Flowing Through SR1

Subsequent to the second step, AT1 is turned off, thereby generating SR1I to flow using the coil's energy. SR1I flows following the path shown in (c) of FIG. 4.

The path followed by SR1I may be described from a different point of view. A description will be given particularly of the current through FR1 in (c) of FIG. 4. FIG. 4 shows both RFI and SR1I for FR1. RFI denotes a current flowing upward in FR1, whereas SR1I denotes a current flowing downward in FR1. These currents, flowing in opposite directions through FR1, cancel each other at least to some extent.

### Third Step, Second Substep: Applying First Reverse Voltage Across Rectifier Circuit 1

SR1I increases beyond RFI, which in turn increases RFV. To describe it in detail, the current that remains after the cancellation in FR1 flows downward in (c) of FIG. 4, thereby charging the parasitic capacitance of FR1 and increasing voltage across the rectifier circuit 1. In other words, the coil's energy generates the first reverse voltage across the rectifier circuit 1.

Fourth Step: Applying Second Reverse Voltage across Rectifier Circuit 1

In the fourth step, SWT1 is turned on, thereby applying the second reverse voltage across the rectifier circuit 1. The second reverse voltage may be applied by one of various methods available in accordance with the type of the power supply circuit.

A transient current (RFI in the reverse direction) flows simultaneously with the application of the reverse voltage, charging the parasitic capacitance of FR1. The transient current flows following the path denoted by RFI in (d) of FIG. 4. There is another current (not shown in (d) of FIG. 4) that flows following a path, HV1 (positive terminal)→SWT1→CO1→LO1→HV1 (negative terminal), since the start of the fourth step.

### Theoretical Basis for Transient Current Reduction by FR1I

in the rectifier circuit 1, a reverse voltage is applied, generating a transient current, while SR1I is flowing following such a path as to charge the parasitic capacitance of FR1. In other words, the parasitic capacitance of FR1 can be charged by FR1I and RFI. The transient current hence decreases by as much as FR1I. Accordingly, the transient current can be effectively reduced over conventional techniques.

### Theoretical Basis for Transient Current Reduction by First Reverse Voltage

As described earlier, the second reverse voltage is 400 V. In Embodiment 1, since the first reverse voltage of approximately 22 V is already being applied in the third step, RFV is increased by as much as the first reverse voltage. Therefore, the second reverse voltage, additionally applied in the fourth step, is equal to 400 V minus approximately 22 V given by the first reverse voltage(=approximately 378 V). This mechanism can more effectively reduce the transient current than conventional techniques.

Since the first reverse voltage is instantaneous, the voltage application ends immediately. For this reasons, the second reverse voltage is preferably continuously applied while the first reverse voltage is being applied.

It may be difficult in some cases to exactly determine the timing of the application of the second reverse voltage due to the adverse effect of ringing by the parasitic component. In such cases, an exact timing can be determined from changes in RFI. Specifically, FIG. 3 shows that RFI decays abruptly at CP. The abrupt decay of RFI is attributable to the start of changes in the voltage applied to the rectifier circuit 1. It is therefore determined that the timing indicated by CP in FIG. 3 is the timing of the application of the second reverse voltage.

### Transient-Current Reducing Effect

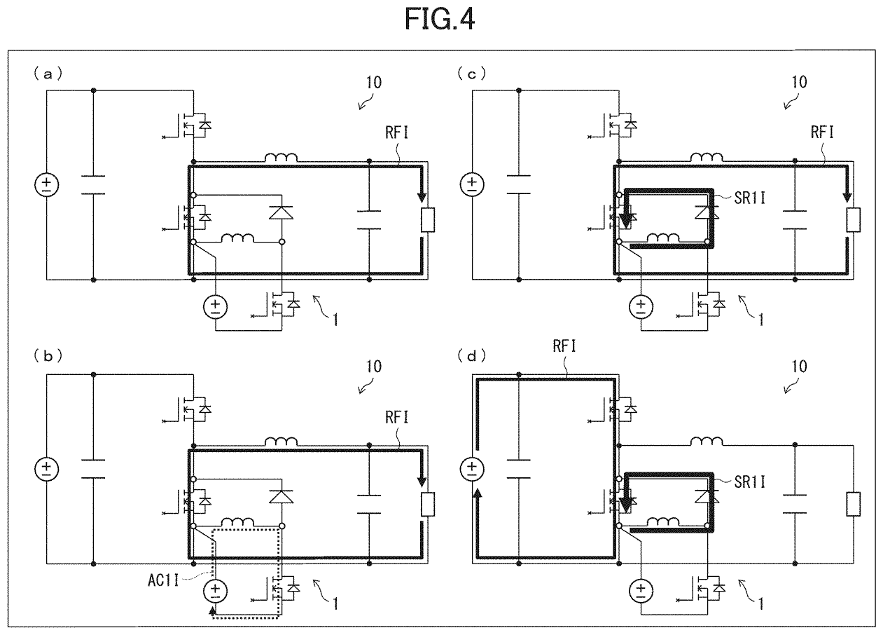

Referring to FIGS. 3 and 5, a description will be given of a transient-current reducing effect of the rectifier circuit 1. FIG. 5 is a graph representing the waveforms of a rectifier circuit voltage (RFVc) and a rectifier circuit current (RFIc) in the power supply circuit. The horizontal and vertical axes of the graph in FIG. 5 have the same scale as those in the graph in FIG. 3.

### Transient Current in Comparative Example

Referring to FIG. 5, transient current is now described that occurs in a rectifier circuit of the power supply circuit. In the comparative example, a transient current (negative RFIc) flows when a reverse voltage (RFVc) of 400 V is applied. FIG. 5 does not show voltages in excess of 30 V due to the scale constraints of the vertical axis. RFVc however reaches 400 V, thereby generating a transient current of approximately 26 A in the power supply circuit.

### Transient Current in Rectifier Circuit 1

Referring to FIG. 3, transient current is now described that occurs in the rectifier circuit 1. In the rectifier circuit 1, a reverse voltage (RFV) of 400 V is applied similarly to the comparative example. The transient current (negative RFI) is however approximately 13 A in the rectifier circuit 1, which demonstrates that the rectifier circuit 1 can reduce transient current over the comparative example.

### Features 1 to 3 for Efficient Operation of Rectifier Circuit 1

Embodiment 1 has desirable features as detailed in the following.

### Feature 1: Applying Second Reverse Voltage After First Reverse Voltage Reaches 5 V or Higher

The example of Embodiment 1 reduces transient current by applying the first reverse voltage of approximately 22 V. Transient current can be reduced more by increasing the first reverse voltage, as an example.

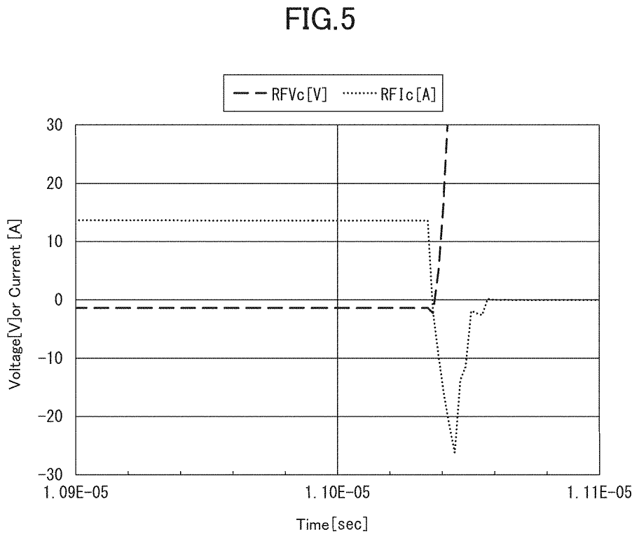

FIG. 6 is a graph representing an example of the reverse voltage (VDS) dependency of the parasitic capacitance (Coss) of a device (e.g., FR1).

Coss increases with a decrease in VDS. Coss is large when VDS is 50 V or lower and extremely large when VDS is 5 V or lower.

Extremely large Coss for 5 V or lower VDS can be charged by setting the first reverse voltage to no higher than 5 V. In addition, by setting the first reverse voltage to 50 V, large Coss for 5 V to 50 V VDS can be charged as well as extremely large Coss for 5 V or lower VDS.

Therefore, the first reverse voltage preferably has a prescribed, 5 V or higher voltage value. Coss is further charged by setting the first reverse voltage to higher than or equal to 50 V.

Feature 2: First Reverse Voltage is from 12% to 88% Second Reverse Voltage

Much coil energy is required however to charge Coss to a higher voltage using the first reverse voltage. It is therefore not preferable that the charge voltage for Coss is too high.

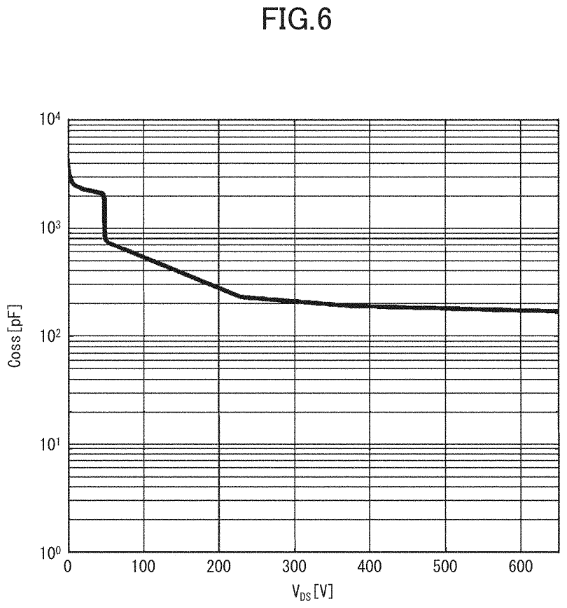

FIG. 7 is a schematic graph representing the voltage dependency of Coss in FR1 and SWT1. The horizontal axis in the graph shows VDS across FR1, whereas the vertical axis shows Coss of each device. A reversed voltage for FR1 is applied to SWT1. Therefore, Coss of SWT1 has a reverse value for Coss of FR1, using VDS=200 V as the reference.

FR1SWT1 is a sum of Coss of FR1 and Coss of SWT1. Coss charged/discharged by SR1I is equal to this FR1SWT1. In FR1SWT1, Coss decreases with an increase in VDS, and no appreciable charge energy increases are therefore needed, for VDS from 0 V to 200 V. Coss can be hence charged efficiently up to 200 V. At 350 V or above, however, Coss is so large that it is impossible to efficiently utilize the coil's energy. The first reverse voltage is thus preferably from 50 V to 350 V.

With all these respects considered, the first reverse voltage is preferably from 12% to 88% (both inclusive) the second reverse voltage.

The value (400 V) of the second reverse voltage shown in FIG. 7 may be changed in a suitable manner in accordance with the circuit voltage and the rectifier breakdown voltage. Coss of a rectifier changes with the rectifier breakdown voltage (circuit voltage). The percentage range given above is therefore suitable.

The first reverse voltage has a value that changes with FR1I and time. The value of the first reverse voltage given above is the value of the first reverse voltage immediately before the second reverse voltage is applied.

Feature 3: Voltage of AV1 Being Lower than Second Reverse Voltage

The voltage of AV1 is preferably low because AT1 causes switching loss. No second reverse voltage (400 V) is used in Embodiment 1. Instead, AV1 is used which is a voltage source for a lower voltage. This arrangement can reduce switching loss caused by AT1.

The voltage of AV1 is specified to be lower than or equal to 20 V which is a rated voltage of the control terminal (gate terminal) of AT1. This specification enables the use of AV1 as a gate-driving power supply for AT1. The control circuit 9 in FIG. 8 includes a built-in gate-driving power supply for AT1.

Meanwhile, the voltage of AV1 preferably has such a value (at least 5 V) that a transistor (e.g., AT1) can operate in its saturation region, in order to reduce conductance loss in AT1.

AV1 is higher than or equal to 5 V and is lower than the second reverse voltage in Embodiment 1. In addition, AV1 is lower than the rated voltage of the control terminal of AT1.

### Variation Examples: Variations of Devices

In Embodiment 1, FR1 is a cascode GaN HEMT, and SR1 is a SiC-SBD. These devices are not limited in any particular manner so long as they fall in one of the above-described device types. Likewise, SWT1 is not limited to any particular type so long as it has a transistor function. The rectifier can have its conductance loss reduced by employing commonly used synchronized rectification.

### Embodiment 2

The rectifier circuit in accordance with an aspect of the present disclosure is applicable to power supply circuits provided with a rectifier circuit. Examples of such a power supply circuit include a chopper circuit, an inverter circuit, and a PFC (power factor correction) circuit.

FIG. 8 is a diagram of a power supply unit 100 including a power supply circuit 10. The rectifier circuit 1 is capable of reducing loss in the power supply circuit 10 and the power supply unit 100. The power supply circuit 10 further includes a control circuit 9. The control circuit 9 controls the turning-on/off of each device in the power supply circuit 10. The control circuit 9 in particular includes a built-in gate-driving power supply (voltage: 15 V) for turning on/off AT1. The gate-driving power supply is connected to AV1. The first to fourth steps may be performed by the control circuit 9 controlling the turning-on/off of each device in the power supply circuit 10.

### General Description

The present disclosure, in aspect 1 thereof, is directed to a rectifier circuit causing a rectification current to flow from a second terminal to a first terminal, the rectifier circuit including: a third terminal between the first terminal and the second terminal; a first rectifier connected to the first terminal and the second terminal; a second rectifier connected to the first terminal and the third terminal; a coil connected to the third terminal and the second terminal; a transistor having a drain or collector connected to the third terminal; and a power supply having a positive terminal connected to the second terminal and a negative terminal connected to a source or emitter of the transistor, wherein the coil applies a first reverse voltage across the rectifier circuit.

A transient current causes a loss in a circuit as described above. In view of this phenomenon, the inventor of the present application has reached this structure from a concept that a coil's energy can contribute to restraints of transient current.

In the structure, a current flows in the coil when the transistor is turned on, enabling the coil to accumulate energy. Then when the transistor is turned off, the energy is converted to a second rectifier current. The transient current is thereby reduced.

The second rectifier current serves to cause a current component that can be a transient current to flow in the path formed by the coil, the second rectifier, and the first rectifier and to apply a first reverse voltage to the rectifier circuit.

In the rectifier circuit of aspect 2 of the present disclosure, a second reverse voltage is applied across the rectifier circuit subsequently to the first reverse voltage.

According to this structure, the two reverse voltages are successively applied. The first reverse voltage is generated by the coil's energy and lasts for a limited length of time. Successively applying the second reverse voltage can extend the application time of the reverse voltages.

In the rectifier circuit of aspect 3 of the present disclosure, the second reverse voltage is applied across the rectifier circuit after the first reverse voltage reaches 5 V or above.

According to this structure, the first reverse voltage can charge extremely large Coss for VDS of lower than 5 V in the first rectifier. Therefore, transient current can be effectively reduced.

In the rectifier circuit of aspect 4 of the present disclosure, the first reverse voltage is from 12% to 88%, both inclusive, the second reverse voltage.

According to this structure, the first reverse voltage can be applied within a range where the coil's energy can be effectively used.

In the rectifier circuit of aspect 5 of the present disclosure, the power supply supplies a voltage lower than the second reverse voltage.

According to this structure, the transistor can be turned on/off using a lower voltage, which in turn reduces switching loss in the transistor.

The present disclosure, in aspect 6 thereof, is directed to a power supply unit including the rectifier circuit of any aspect of the present disclosure.

According to this structure, the use of the rectifier circuit in which transient current is reduced realizes a power supply unit in which loss is reduced.

### ADDITIONAL REMARKS

The present disclosure, in an aspect thereof, is not limited to the description of the embodiments above and may be altered within the scope of the claims. Embodiments based on a proper combination of technical means disclosed in different embodiments are encompassed in the technical scope of the aspect of the present disclosure. Furthermore, a new technological feature can be created by combining different technological means disclosed in the embodiments.

### REFERENCE SIGNS LIST

1 Rectifier Circuit
9 Control Circuit
10 Power Supply Circuit
100 Power Supply Unit
FR1 First Rectifier
SR1 Second Rectifier
FT1 First Terminal
ST1 Second Terminal
TT1 Third Terminal
AC1 Coil
AT1 Transistor
AV1 Power Supply

What is claimed is:

1. A rectifier circuit causing a rectification current to flow from a second terminal to a first terminal, the rectifier circuit comprising:
a third terminal between the first terminal and the second terminal;
a first rectifier connected to the first terminal and the second terminal;
a second rectifier connected to the first terminal and the third terminal;
a coil connected to the third terminal and the second terminal;
a transistor having a drain or collector connected to the third terminal; and
a power supply having a positive terminal connected to the second terminal and a negative terminal connected to a source or emitter of the transistor,
wherein the coil applies a first reverse voltage across the rectifier circuit.

2. The rectifier circuit according to claim 1, wherein a second reverse voltage is applied across the rectifier circuit subsequently to the first reverse voltage.

3. The rectifier circuit according to claim 1, wherein the second reverse voltage is applied across the rectifier circuit after the first reverse voltage reaches a prescribed, 5 V or higher voltage value.

4. The rectifier circuit according to claim 2, wherein the second reverse voltage is applied across the rectifier circuit after the first reverse voltage reaches a prescribed, 5 V or higher voltage value.

5. The rectifier circuit according to claim 2, wherein the first reverse voltage is from 12% to 88%, both inclusive, the second reverse voltage.

6. The rectifier circuit according to claim 3, wherein the first reverse voltage is from 12% to 88%, both inclusive, the second reverse voltage.

7. The rectifier circuit according to claim 4, wherein the first reverse voltage is from 12% to 88%, both inclusive, the second reverse voltage.

8. The rectifier circuit according to claim 2, wherein the power supply supplies a voltage lower than the second reverse voltage.

9. The rectifier circuit according to claim 3, wherein the power supply supplies a voltage lower than the second reverse voltage.

10. The rectifier circuit according to claim 4, wherein the power supply supplies a voltage lower than the second reverse voltage.

11. The rectifier circuit according to claim 5, wherein the power supply supplies a voltage lower than the second reverse voltage.

12. The rectifier circuit according to claim 6, wherein the power supply supplies a voltage lower than the second reverse voltage.

13. The rectifier circuit according to claim 7, wherein the power supply supplies a voltage lower than the second reverse voltage.

14. A power supply unit comprising the rectifier circuit according to claim 1.
